(19) United States
(12) Patent Application Publication
(10) Pub. No.: US 2007/0127965 A1
(43) Pub. Date: Jun. 7, 2007

(54) Apparatus, system, and method for modifying print parameters

(76) Inventors: William Gabriel Pagan, Durham, NC (US); David C. Wu, Apex, NC (US)

Correspondence Address: KUNZLER & ASSOCIATES, 8 EAST BROADWAY, SUITE 600, SALT LAKE CITY, UT, 84111, US

(21) Appl. No.: 11/294,160

(22) Filed: Dec. 5, 2005

(51) Int. Cl. B41J 5/30

(52) U.S. Cl. 400/61

(57) ABSTRACT

An apparatus, system, and method are disclosed for modifying print parameters. In one embodiment, a scanner automatically scans a print media and/or packaging for the print media. In an alternate embodiment, a RFID interrogator interrogates an RFID for the print media and/or print media packaging. A detection module detects an identifier of the print media, a printed image on the print media, and/or print media packaging. The identifier may be one or more symbols and/or one or more physical characteristics. An attribute module determines an attribute of the print media in response to the identifier. The attribute is relevant to color calibration for printing on the print media. A modification module modifies a print parameter in response to the attribute. The print parameter may modify a rendition command that renders a digital image on the print media.

### BACKGROUND OF THE INVENTION

1. Field of the Invention

This invention relates to modifying print parameters and more particularly relates to automatically modifying print parameters in response to a print media identifier.

2. Description of the Related Art

Digital printing applications are growing rapidly, with digital printers used extensively for color and black and white printing on a variety of print media such as paper, card stock, adhesive labels, photographic paper, or the like. For example, color printers may print photographs as well as greeting cards, presentations, reports, and other documents. A digital printer typically applies one or more inks, dyes, toners, and/or other rendering materials (referred to herein as ink) in specified ratios to a print media such as glossy photo paper to create a specified color, tone, and/or shade.

Unfortunately, the chemistry of the print media often impacts the appearance of the printed print media. For example, the color and/or tone of the print media may alter the apparent color and/or tone of ink on the print media. In addition, the porousness, thickness, absorbance, composition, transparency, gloss, texture, and contaminants may also affect the appearance of the ink on the print media.

As a result, print media manufacturers often supply data on the print media that can be entered or downloaded to adjust the proportions of the inks used in printing. The data may include color balancing data. Unfortunately, users are often reluctant to acquire and apply print media data, so that images rendered on a print media may deviate from the desired tone and/or color.

From the foregoing discussion, it should be apparent that a need exists for an apparatus, system, and method that automatically acquires print media data and modifies print parameters. Beneficially, such an apparatus, system, and method would improve the fidelity of a rendered image to the desired colors and/or tones.

### SUMMARY OF THE INVENTION

The present invention has been developed in response to the present state of the art, and in particular, in response to the problems and needs in the art that have not yet been fully solved by currently available print parameter modification methods. Accordingly, the present invention has been developed to provide an apparatus, system, and method for modifying print parameters that overcome many or all of the above-discussed shortcomings in the art.

The apparatus to modify print parameters is provided with a plurality of modules configured to functionally execute the steps of detecting an identifier, determining an attribute, and modifying a print parameter. These modules in the described embodiments include a detection module, an attribute module, and a modification module.

The detection module detects an identifier of a print media. The identifier may be one or more symbols such as a bar code, a product code such as a universal product code (“UPC”), a watermark, or the like. In an alternate embodiment, the identifier may be a physical characteristic of the print media. For example, the physical characteristic may be color, tint, porousness, thickness, absorbance, composition, transparency, gloss, texture and contamination. The detection module may detect the identifier from a scan of the print media. The detection module may also detect the identifier from a scan of packaging for the print media. In one embodiment, the detection module detects a printed image on the print media as the identifier.

In a certain embodiment, a radio frequency identification device (“RFID”) communicates the identifier. The detection module may comprise an RFID interrogator that receives the identifier from the RFID.

The attribute module determines an attribute of the print media in response to the identifier. The attribute is relevant to color calibration for printing on the print media. The attribute may be a color attribute, a texture attribute, an absorbance attribute, or the like.

The modification module modifies a print parameter in response to the attribute. The print parameter may be used to modify a rendition command directed to printing a digital image on the print media. The apparatus modifies the print parameter in response to the identifier from the print media, improving the fidelity of the printed image.

A system of the present invention is also presented to modify a print parameter. The system may be embodied in a print system. In particular, the system, in one embodiment, includes a printer, a detection module, an attribute module, and a modification module. The printer may comprise a paper transport, a scanner, a print controller, and a print engine. In one embodiment, the system further includes a host.

The printer is configured to print on paper. In one embodiment, the printer receives digital data that describes an image. The printer may receive the digital data from a host. The host may be an external device such as a print server, computer workstation, or the like. The print controller may convert the digital image data into one or more rendition commands. The rendition command is modified by a print parameter. The print engine prints the image on the paper as the paper in response to the rendition command transport moves the paper through the printer.

The scanner scans the paper. In one embodiment, the scanner automatically scans the paper as the paper transport moves the paper through the printer. In an alternate embodiment, a user manually scans the paper. The detection module detects an identifier of the paper from the scan. The attribute module determines an attribute of the paper in response to the identifier. The modification module modifies the print parameter in response to the attribute.

In one embodiment, the detection module, attribute module, and/or modification module are embodied in software. The detection module, attribute module, and/or modification module may reside on the host. In addition, the detection module, attribute module, and/or modification module may be a device driver. Alternatively, the detection module, attribute module, and/or modification module may be application software. The system scans an identifier and modifies the print parameter in response to the identifier.

A method of the present invention is also presented for modifying a print parameter. The method in the disclosed embodiments substantially includes the steps to carry out the functions presented above with respect to the operation of the described apparatus and system. In one embodiment, the method includes automatically scanning a print media, detecting an identifier, determining an attribute, and modifying a print parameter.

In one embodiment, a scanner automatically scans a print media and/or packaging for the print media. In an alternate embodiment, a RFID interrogator interrogates an RFID for the print media and/or print media packaging. A detection module detects an identifier of the print media and/or print media packaging. The identifier may be one or more symbols and/or one or more physical characteristics. An attribute module determines an attribute of the print media in response to the identifier. The attribute is relevant to color calibration for printing on the print media. A modification module modifies a print parameter in response to the attribute. The print parameter may modify a rendition command that renders a digital image on the print media. The method modifies the print parameter in response to the detected identifier, improving the quality of the printed image on the print media.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The present invention detects an identifier of a print media, determines an attribute of the print media in response to the identifier, and modifies a print parameter in response to the attribute. In addition, the present invention may improve the fidelity of a rendered image. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective drawing illustrating one embodiment of a printer in accordance with the present invention;

FIG. 2 is a perspective drawing illustrating one embodiment of printer components in accordance with the present invention;

FIG. 3 is a schematic block diagram illustrating one embodiment of a print media apparatus of the present invention;

FIG. 4 is a schematic block diagram illustrating one embodiment of a print controller of the present invention;

FIG. 5 is a schematic block diagram illustrating one embodiment of an RFID of the present invention;

FIG. 6 is a schematic block diagram illustrating one embodiment of an RFID receiver of the present invention;

FIG. 7 is a schematic flow chart diagram illustrating one embodiment of a print parameter modification method of the present invention; and

FIG. 8 is a schematic block diagram illustrating one embodiment of an identifier database of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

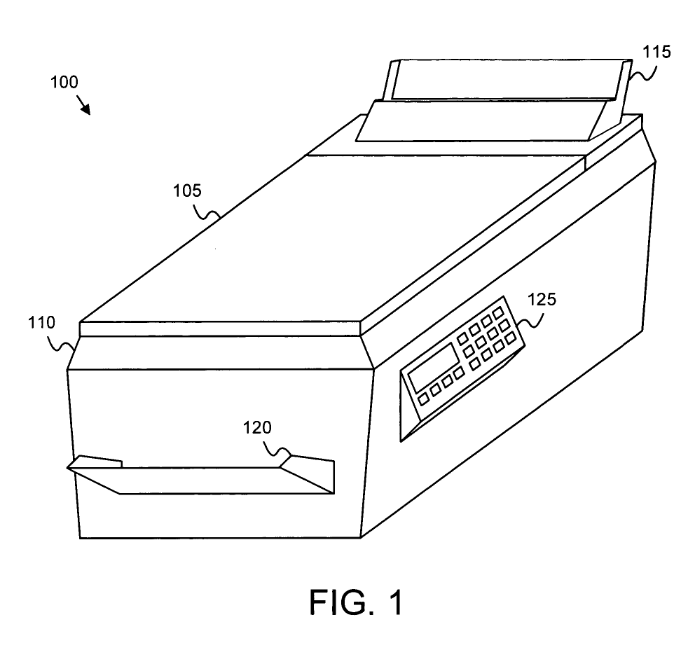

FIG. 1 is a perspective drawing illustrating one embodiment of a printer 100 in accordance with the present invention. In one embodiment, the printer 100 is configured to print, scan, and copy as is well known to those skilled in the art. The printer 100 includes a scanner cover 105, a printer body 110, a document feeder 115, an output tray 120, and a control panel 125.

The printer 100 prints a digital image on a print media as will be described hereafter. The print media may be paper, card stock, adhesive labels, photographic paper, transparencies, or the like. The printer 100 may transport the print media from an internal print media store, print one or more images on the print media, and transport the printed print media to the output tray 120.

The printer 100 may also function as a copier, wherein a user places a document in the document feeder 115 or beneath the scanner cover 105. The printer 100 may scan the document using an internal scanner (not shown) and print the scanned image. The user may control print, scan, and copy functions using the control panel 125.

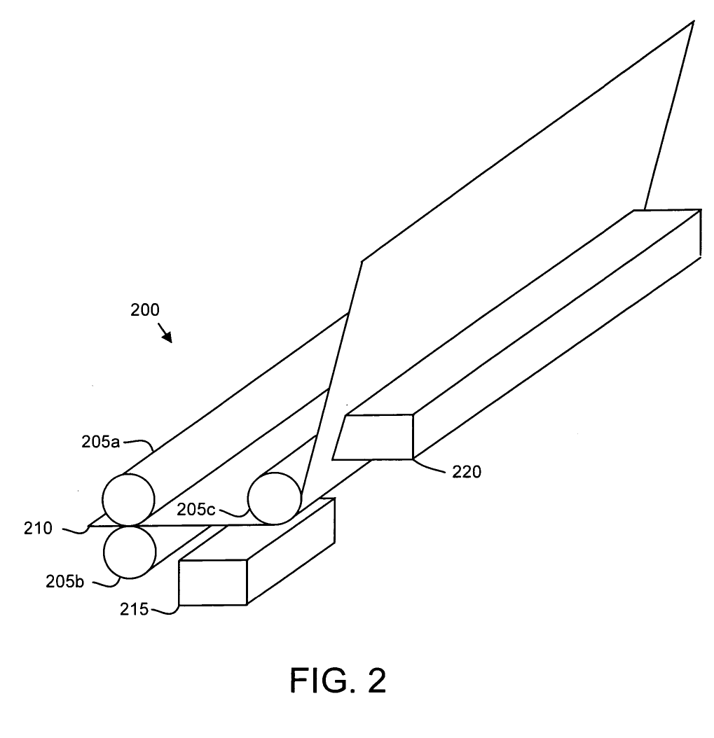

FIG. 2 is a perspective drawing illustrating one embodiment of printer components 200 in accordance with the present invention. The components 200 may be embodied in the printer 100 of FIG. 1. Alternatively, the components 100 may be embodied in a plurality of printers including inkjet printers, impact printers, thermal printers, laser printers, and the like embodied in a plurality of printer configurations in addition to the combination printer, scanner, copier of FIG. 1.

The components include one or more rollers 205, a scanner 215, and a print engine 220. A print media 210 is depicted being transported by the rollers 205. In one embodiment, the rollers are embodied in a paper transport. The paper transport may include one or more motors, gears, belts, sensors, and baffles as are well known to those skilled in the art. For example, a motor may drive a belt that drives each roller 205 to move the print media 210 through the printer 100.

In one embodiment, the paper transport moves the print media 210 past the scanner 215. The scanner 215 may automatically scan the print media 210. In one embodiment, the scanner 215 may scan a portion of the print media 210. In an alternate embodiment, the scanner 215 may scan all of the print media 210.

The print engine 220 prints on the print media 210 in response to a rendition command. The rendition command may be received from a print controller as will be described hereafter. The print engine 220 may utilize a print head such as an inkjet print head, an impact print head and ribbon, a thermal print head, or the like to print on the print media 210. Alternatively, the print engine 220 statically charge a print drum (not shown) with a laser, apply toner to the charged portions of the drum, and apply the toner from the drum to the print media 210.

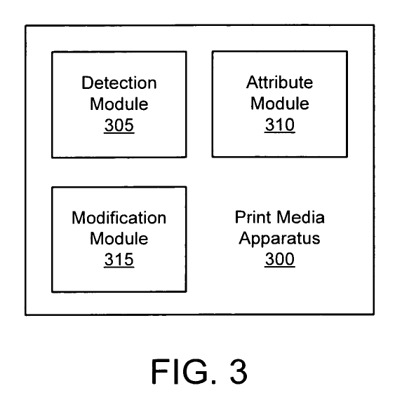

FIG. 3 is a schematic block diagram illustrating one embodiment of a print media apparatus 300 of the present invention. The apparatus 300 includes a detection module 305, an attribute module 310, and a modification module 315. The apparatus 300 may be embodied in the printer 100 of FIG. 1. In addition, the description of the apparatus 300 refers to elements of FIGS. 1 and 2, like numbers referring to like elements.

The detection module 305 detects an identifier of the print media 210. The identifier may be one or more symbols such as a bar code, a product code, a watermark, or the like. In an alternate embodiment, the identifier may be one or more physical characteristics of the print media 210. For example, the physical characteristic may be color, tint, porousness, thickness, absorbance, composition, transparency, gloss, texture and contamination.

The detection module 305 may detect the identifier from a scan of the print media 210 as described in FIGS. 1 and 2. The detection module 305 may also detect the identifier from a scan of packaging for the print media 210. In a certain embodiment, a radio frequency identification device (“RFID”) communicates the identifier as will be described hereafter.

The attribute module 310 determines an attribute of the print media 210 in response to the identifier. The attribute is relevant to color calibration for printing on the print media 210. The attribute may be a color attribute, a texture attribute, an absorbance attribute, or the like.

The modification module 315 modifies a print parameter in response to the attribute. The print parameter may modify a rendition command that is directed to the print engine 220 to adjust the printing of a digital image. The apparatus 300 modifies the print parameter in response to the identifier from the print media 210, improving the fidelity of the printed image.

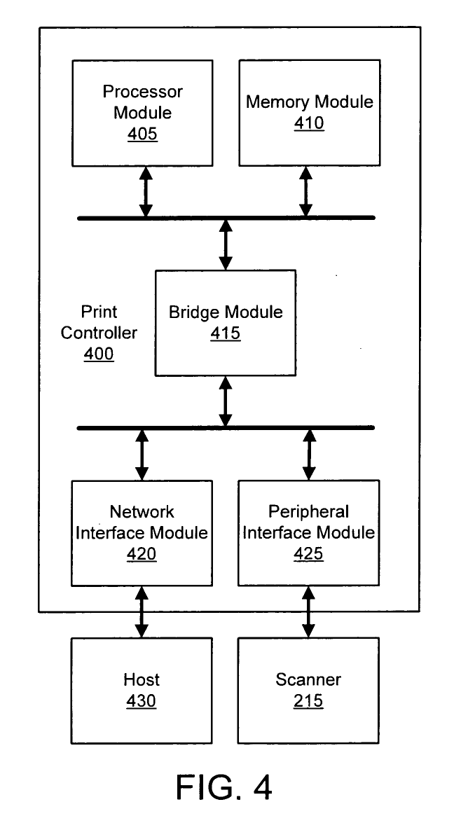

FIG. 4 is a schematic block diagram illustrating one embodiment of a print controller 400 of the present invention. The controller 400 includes a processor module 405, a memory module 410, a bridge module 415, a network interface module 420, and a peripheral interface module 425. In addition, the controller is shown in communication with a host 430, and a scanner 215. The controller 400 may be embodied in the printer 100 of FIG. 1 and control the print components 200 of FIG. 2. In addition, the description of the controller 400 refers to elements of FIGS. 1-3, like numbers referring to like elements.

The processor module 405, memory module 410, bridge module 415, network interface module 420, and peripheral interface module 425 may be fabricated of semiconductor gates on one or more semiconductor substrates. Each semiconductor substrate may be packaged in one or more semiconductor devices mounted on circuit cards. Connections between the processor module 405, the memory module 410, the bridge module 415, the network interface module 420, and the peripheral interface module 425 may be through semiconductor metal layers, substrate to substrate wiring, or circuit card traces or wires connecting the semiconductor devices.

The memory module 410 stores software instructions and data. The processor module 405 executes the software instructions and manipulates the data as is well know to those skilled in the art. The processor module 405 communicates with the network interface module 420 and the peripheral interface module 425 through the bridge module 415.

The processor module 405 may communicate with the host 430 through the bridge module 415 and the network interface module 420. The network interface module 420 may be an Ethernet interface, a universal serial bus (“USB”) interface, or the like. The host 430 may be device external to the printer 100 such as a print server, computer workstation, or the like.

In one embodiment, the memory module 410 stores and the processor module 405 executes one or more software processes comprising the detection module 305, attribute module 310, and/or modification module 315 of FIG. 3. In an alternate embodiment, the host 430 executes one or more software processes comprising the detection module 305, attribute module 310, and/or modification module 315.

In one embodiment, the processor module 405 communicates with the scanner 215 through the bridge module 415 and the peripheral interface module 425. The peripheral interface module 425 may be a dedicated digital bus, a USB interface, a serial port interface, or the like. The scanner may be the inline scanner 215 of FIG. 2. Alternatively, the scanner 215 may be a flatbed scanner as embodied in the printer 100 of FIG. 1.

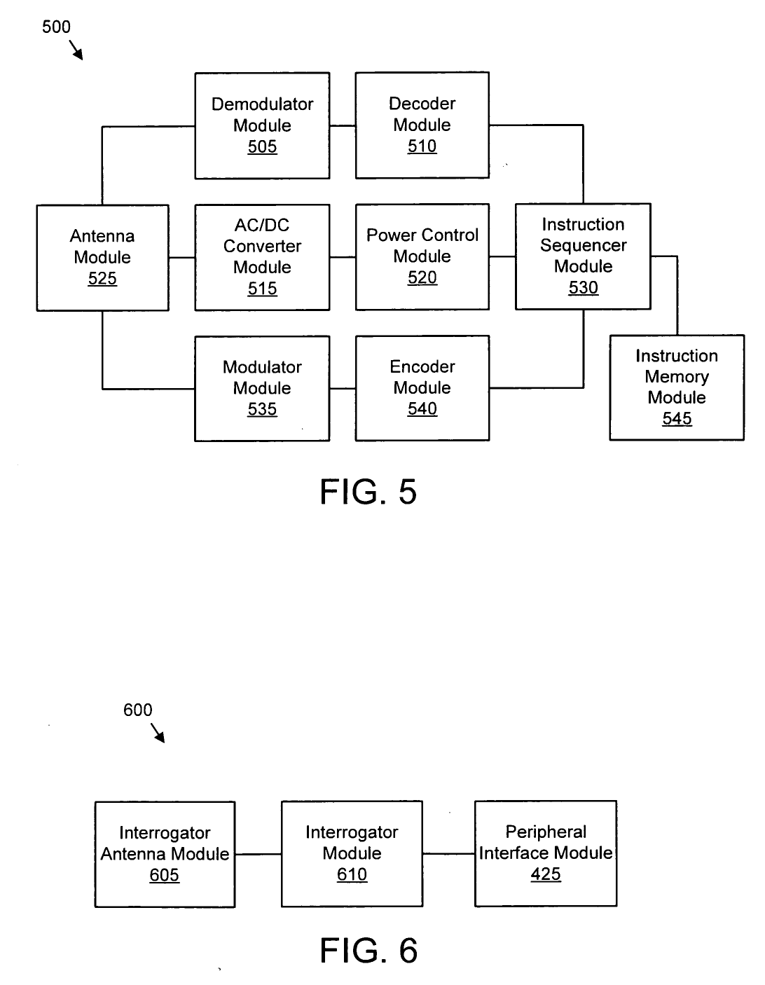

FIG. 5 is a schematic block diagram illustrating one embodiment of an RFID 500 of the present invention. The RFID 500 includes a demodulator module 505, a decoder module 510, an alternating current/direct current (“AC/DC”) converter module 515, a power control module 520, an antenna module 525, an instruction sequencer module 530, a modulator module 535, an encoder module 540, and an instruction memory module 545. The RFID 500 may be embodied in a semiconductor device.

In one embodiment, the antenna module 525 receives a radio frequency transmission from an interrogator module that will be described hereafter. The AC/DC converter module 515 converts the received transmission into direct current (“DC”) electricity that powers the RFID 500. The power control module 520 controls the DC electricity within the modules of the RFID 500.

The demodulator module 505 demodulates a signal from the interrogator module. The decoder module 510 decodes the signal. The signal may be a request for the RFID 500 to respond with an identifier. The instruction sequencer module 530 executes a software process stored in the instruction memory module 535.

In one embodiment, the instruction sequencer 530 responds to the decoded signal from the interrogator module by replying to the interrogator module with the identifier. The identifier may be an identification number. The encoder module 540 may encode the identifier and the modulator module 535 may modulate the encoded identifier as a reply signal. The antenna module 525 transmits the replay signal to the interrogator module.

FIG. 6 is a schematic block diagram illustrating one embodiment of an RFID receiver 600 of the present invention. The RFID receiver 600 includes an interrogator antenna module 605, an interrogator module 610, and a peripheral interface module 425. The description of the RFID receiver 600 refers to elements of FIGS. 4 and 5, like numbers referring to like elements.

The peripheral interface module 425 may be in communication with the processor module 405 of the print controller 400. Alternatively, the peripheral interface module 425 may be in communication with the host 430. The peripheral interface module 425 may receive a command directing the interrogator module 610 to interrogate one or more RFIDs 500. In addition, the peripheral interface module 425 may relay the command to the interrogator module 610.

The interrogator module 610 may compose a signal directing each RFID 500 receiving the signal to respond with an identifier. In addition, the interrogator module 610 may transmit the signal through the interrogator antenna module 605 as is well known to those skilled in the art. The RFID 500 responds to the signal with a reply signal as described for FIG. 5. The interrogator module 610 may decode the reply signal to yield the identifier. In addition, the interrogator module 610 may communicate the identifier to the host 430 and/or the processor module 405 through the peripheral interface module 425.

The schematic flow chart diagram that follows is generally set forth as a logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

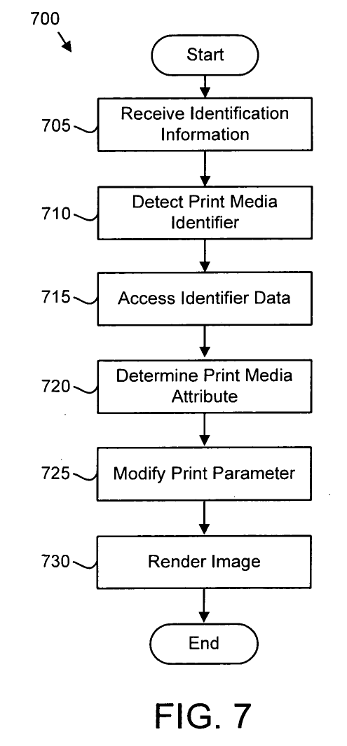

FIG. 7 is a schematic flow chart diagram illustrating one embodiment of a print parameter modification method 700 of the present invention. The method 700 substantially includes the steps to carry out the functions presented above with respect to the operation of the described printer 100 and apparatus 200, 300, 400, 500, 600 of FIGS. 1-6. In addition, the method 700 refers to elements of FIGS. 1-6, like numbers referring to like elements.

The method 700 begins and an identification device such as the scanner 215 and/or the RFID interrogator 610 receives 705 identification information such as a scan or a reply signal. The detection module 305 may comprise the identification device. In one embodiment, the scanner 215 automatically scans a print media 210 and/or packaging for the print media 210. For example, the scanner 215 may automatically scan the print media 210 as the paper transport moves the print media 210 through the printer 100.

In an alternate embodiment, a user may manually scan the print media 210 and/or the print media packaging and indicate to the printer 100 that the scan is to identify the print media 210. For example, the user may place the print media 210 and/or print media packaging beneath the scanner cover 105 of the printer 100 and direct the printer 100 through the control panel 125 to identify the print media 210. The printer 100 may scan the print media 210 and/or print media packaging.

In a certain embodiment, the scanner 215 scans a printed image on the print media 210. For example, the print engine 220 may print the printed image on the print media 210. The scanner 215 may scan the printed image before the print media 210 exits the printer 100. Alternatively, the user may manually scan the printed image and direct the printer 100 through the control panel 125 to adjust a print parameter in response to the printed image.

In an alternate embodiment, the interrogator module 610 interrogates an RFID for the print media and/or print media packaging, and receives 705 an encoded identifier. For example, the interrogator module 610 may periodically transmit a signal through the interrogator antenna module 605 requesting any RFID 500 to respond with an identifier such as an identification number. In response, an RFID 500 mounted on packaging for print media 210 may transmit a reply signal to the interrogator antenna module 605. The interrogator module 610 may demodulate and decode the reply signal to yield the identifier.

The detection module 305 detects 610 the identifier of the print media 210. In one embodiment, the detection module 305 detects 610 the identifier from the scan of the print media 210 and/or the scan of the print media packaging. For example, the detection module 305 may detect 610 a UPC identifier from a scan of the print media package. The detection module 305 may employ a pattern recognition algorithm tuned to UPC codes to identify the UPC identifier. In addition, the detection module 305 may use a decoding algorithm to decode the UPC identifier.

Alternatively, the detection module 305 may detect 610 an identifier of the print media 210 such as a watermark. For example, the detection module 305 may employ a pattern recognition algorithm tuned to identify a regular pattern. In addition, the detection module 305 may compare a potential watermark pattern to a database of watermark patterns to identify the watermark pattern. The host 430 may maintain the database of watermark patterns. Alternatively, printer 100 may maintain the database of watermark patterns. The detection module 305 may further assign a digital value to the watermark.

In one embodiment, the detection module 305 detects 610 the printed image identifier. The printer 100 may print the printed image on the print media 210 as a calibration mark. The detection module 305 may locate the printed image from a rendition command directed to printing the printed image.

In a certain embodiment, the detection module 305 detects 610 the identifier from a communication such as one or more digital values communicated from the interrogator module 610 to the host 430 and/or the processor module 405. The detection module 305 may parse the digital values to detect 610 the identifier.

For example, the interrogator module 610 receive identifiers from a plurality of RFIDs 500 such as an RFID 500 included in an inventory sticker attached to a fax machine, an RFID 500 included in an inventory sticker attached to the printer 100, and an RFID 500 attached to print media packaging. The interrogator module 610 may communicate each identifier to the detection module 305.

The detection module 305 may maintain a database of identifiers for print media packaging. In addition, the detection module 305 may determine that the identifiers from the printer 100 and the fax machine are not in the print media packaging database and ignore the printer and fax machine identifiers. The detection module 305 may further determine that print media packaging identifier is included in the print media packaging database, detecting 610 the identifier for the print media packaging.

In one embodiment, the detection module 305 detects 710 the identifier wherein the identifier is a physical attribute of the print media 210. For example, the detection module 305 may detect 610 the color, tint, porousness, thickness, absorbance, composition, transparency, and/or gloss from the scan of the print media 210.

Alternatively, the detection module 305 may filter the scan of the print media 210 to estimate the porousness, thickness, absorbance, composition, texture and/or contamination. In a certain embodiment, the scanner 215 scans a first side of the print media 210 as visible light is applied to a second side of the print media 210. Alternatively, the scanner 215 may scan the print media 210 with infrared light, ultraviolet light, polarized light, collated light, or the like.

The detection module 305 may integrate the scan to yield a digital value for the scan. In addition, the scanner may detect the porousness, thickness, absorbance, composition, texture, and/or contamination of the print media 210 from the scan's digital value. Alternatively, the detection module 305 may apply a digital filter to the scan to yield one or more digital values for the scan. The scan digital value may be the identifier for the print media 210.

In one embodiment, the attribute module 310 accesses 615 identifier data using the identifier. For example, the attribute module 310 may maintain a database of identifiers. The identifier database may include a plurality of identifiers. The identifiers may include UPC values, bar code values, values assigned to watermarks, and the like. In addition, the identifier database may associate one or more attributes with each identifier.

In one embodiment, the attribute module 310 derives the identifier from the difference between the scanned printed image and the rendition command used to print the printed image. For example, if the scanned printed image has a lighter tone than is indicated by the rendition command, the attribute module 310 may derive an identifier for the print media 210 that identifies the print media 210 as lightening the tone of printed images on the printed media 210.

The attribute module 310 further determines 620 an attribute of the print media 210 in response to the identifier. In one embodiment, the attribute module 310 selects the attribute from the identifier database using the identifier and/or a digital value assigned to the identifier as a key to the database. The attribute is relevant to color calibration for printing on the print media 210. For example, the attribute may be the color of print media 210. Alternatively, the attribute may be the tone and/or gloss of the print media 210.

The color, tone, and/or gloss may affect the appearance of a printed image on the print media 210, enhancing or reducing the visual effect of one or more colors. For example, a print media 210 with a high gloss may require a different quantity of ink to render a similar printed image appearance to a low gloss print media 210. In one embodiment, the attribute module 310 determines 620 a plurality of attributes of the print media 210.

The modification module 315 modifies 725 a print parameter in response to the attribute. The print parameter may modify a rendition command that renders a digital image on the print media 210. For example, the print parameter may modify the quantity of a cyan ink that is used to render a dot in an image, wherein the dot has a specified color comprised of cyan, magenta, yellow, and block components. The modification module 315 may modify 725 the print parameter to increase the cyan ink used to render the dot if the attribute indicates that the print media 210 has a cyan color attribute.

For example, the quantity of cyan ink i_{c} used to print the dot may be calculated using Equation 1, where r_{c} is a rendition command value for the quantity of cyan ink and p_{c} is a print parameter modifying the quantity of cyan ink.
i_{c}=(1−p_{c})r_{c} Equation 1

In one embodiment, as the cyan attribute in the print media 210 increases, the value of the print parameter p_{c} increases, reducing the quantity of cyan ink for any value of the rendition command value for cyan ink r_{c}. Thus the modification module 315 may modify 725 the print parameter to modify the rendition of the printed image.

In one embodiment, the printer 100 renders 730 the digital image using the modified print parameter and the method 700 terminates. For example, the printer 100 may print the digital image using a laser printing technology, impact printing technology, inkjet printing technology, thermal printing technology, or the like. The method 700 modifies the print parameter in response to the detected identifier, improving the quality of the printed image on the print media 210.

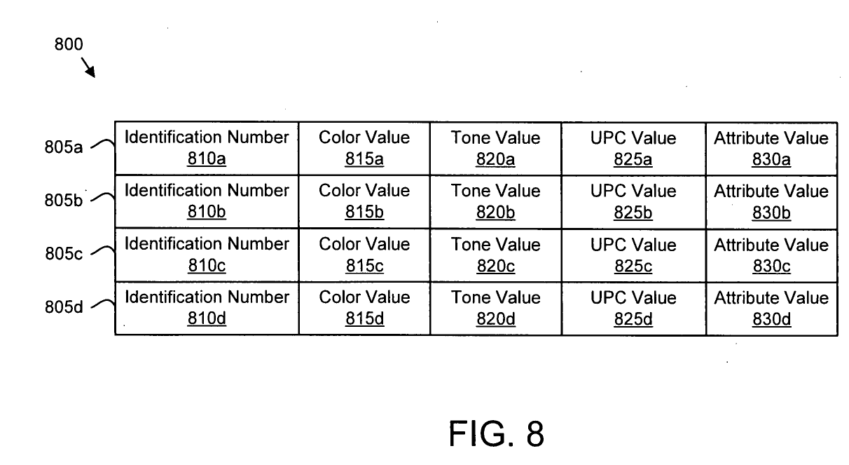

FIG. 8 is a schematic block diagram illustrating one embodiment of an identifier database 800 of the present invention. The database 800 may be used by the attribute module 310 to determine 720 a print media attribute in response to an identifier as described in FIG. 7. In addition, the description of the database 800 refers to elements of FIGS. 1-7, like numbers referring to like elements.

The database 800 includes a plurality of entries 805. For simplicity, each entry 805 is depicted with an identification number data field 810, a color value data field 815, a tone value data field 820, a UPC value data field 825, and an attribute data field 830, each entry 805 may include a plurality of color value data fields 815, tone value data fields 820, UPC value data fields 825, and attribute data fields 830. In an alternate embodiment, each entry may also include one or more gloss value data fields, one or more porousness data fields, one or more thickness data fields, one or more absorbance data fields, one or more composition data fields, one or more transparency data fields, one or more gloss data fields, one or more texture data fields, and one or more contamination data fields.

In one example, the user of the printer 100 may scan a UPC code from the packaging of a print media 210 such as printer paper and using the control panel 125 direct the printer 100 to modify a print parameter in response to the scan. The detection module 305 may detect 710 the UPC code from scan.

The attribute module 310 may access 715 the database 800 and locate an entry 805 with a UPC value in the UPC value data field 825 that matches the UPC code. In addition, the attribute module 310 may determine 720 the attribute for the print media 210 as the attribute of the attribute data field 830 of the entry 805 with the UPC value in the UPC value data field 825 matching the scanned UPC code. For example, if the UPC value in the second UPC value data field 825b matches the scanned UPC code, the attribute module 310 may select the attribute value of the second attribute value data field 830b.

In one embodiment, the attribute value data field 830 describes aspects of the print media 210. For example, the attribute value data field 830 may include values describing the cyan, magenta, yellow, and black color values for the print media 210. Alternatively, the attribute value data field 830 may describe the capacity of the print media 210 to absorb ink.

The present invention detects 710 an identifier of a print media 210, determines 720 an attribute of the print media 210 in response to the identifier, and modifies 725 a print parameter in response to the attribute. In addition, the present invention may improve the fidelity of a rendered image. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to modify print parameters, the apparatus comprising:
a detection module configured to detect an identifier of a print media;
an attribute module configured to determine an attribute of the print media in response to the identifier, wherein the attribute is relevant to color calibration for printing on the print media; and
a modification module configured to modify a print parameter in response to the attribute.

2. The apparatus of claim 1, wherein the detection module comprises a scanner configured to scan the identifier.

3. The apparatus of claim 2, wherein the identifier comprises a physical characteristic of the print media.

4. The apparatus of claim 3, wherein the physical characteristic is selected from color, tint, porousness, thickness, absorbance, composition, transparency, gloss, texture and contamination.

5. The apparatus of claim 2, wherein the scanner scans a printed image on the print media as the identifier.

6. The apparatus of claim 2, wherein the identifier comprises at least one symbol.

7. The apparatus of claim 6, wherein the identifier is selected from a bar code, a product code, and a watermark.

8. The apparatus of claim 1, wherein the detection module comprises a radio frequency module configured to detect a radio frequency identification device (“RFID”).

9. The apparatus of claim 1, where in the modification module resides in software on an external device.

10. The apparatus of claim 9, where in the software is selected from a device driver and application software.

11. A signal bearing medium tangibly embodying a program of machine-readable instructions executable by a digital processing apparatus to perform an operation to modify print parameters, the operation comprising:
automatically scanning a print media;
detecting an identifier of the print media;
determining an attribute of the print media in response to the identifier, wherein the attribute is relevant to color calibration for printing on the print media; and
modifying a print parameter in response to the attribute.

12. The signal bearing medium of claim 11, wherein the identifier comprises a printed image on the print media.

13. The signal bearing medium of claim 11, wherein the identifier is selected from a bar code, a product code, and a watermark.

14. The signal bearing medium of claim 11, wherein the identifier comprises a physical characteristic of the print media.

15. The signal bearing medium of claim 14, wherein the physical characteristic is selected from color, tint, porousness, thickness, absorbance, composition, transparency, gloss, texture and contamination.

16. A system to modify a print parameter, the system comprising:
a printer configured to print on a paper and comprising
a paper transport for moving the paper through the printer;
a scanner configured to scan the paper;
a print controller configured to convert digital image data into a rendition command, wherein the rendition command is modified by a print parameter; and
a print engine configured print on the paper in response to the rendition command; and
a detection module configured to detect an identifier of the paper from a scan of the paper, wherein the identifier is a physical characteristic selected from color, tint, porousness, thickness, absorbance, composition, transparency, gloss, texture and contamination;
an attribute module configured to determine an attribute of the paper in response to the identifier, wherein the attribute is relevant to color calibration for printing on the paper; and
a modification module configured to modify the print parameter in response to the attribute.

17. The system of claim 16, where in the modification module is embodied in software residing on a host.

18. The system of claim 17, where in the software is a device driver.

19. The system of claim 16, wherein the modification module resides in firmware on the printer.

20. A method for deploying computer infrastructure, comprising integrating computer-readable code into a computing system, wherein the code in combination with the computing system is capable of performing the following:
scanning a print media;
detecting an identifier of the print media, wherein the identifier is selected from a bar code, a product code, and a watermark;
accessing identifier data using the identifier as a key;
determining an attribute of the print media in response to the identifier, wherein the attribute is relevant to color calibration for printing on the print media; and
modifying a print parameter in response to the attribute.
